(19) United States
(12) Patent Application Publication
(10) Pub. No.: US 2022/0241635 A1
(43) Pub. Date: Aug. 4, 2022

(54) FIRE SUPPRESSING COMPOSITIONS

(71) Applicant: FIREREIN, INC., Napanee (CA)

(72) Inventors: ZACKERY MICHAEL HODGEN, NAPANEE (CA); DAVID JOHN HYNDMAN, KINGSTON (CA); SAMUEL DUPLESSIS, KINGSTON (CA)

(21) Appl. No.: 17/584,991

(22) Filed: Jan. 26, 2022

Related U.S. Application Data
(60) Provisional application No. 63/143,069, filed on Jan. 29, 2021.

(51) Int. Cl. A62D 1/00

(52) U.S. Cl. CPC A62D 1/0064

(57) ABSTRACT

The present application provides compositions comprising (a) at least one lignin; and (b) at least one polymeric thickening agent. Mixture of said compositions with water or an aqueous solution provides fire suppressing and/or fire-retarding hydrogels. Also provided are hydrogels prepared from the compositions, and methods of using the hydrogels to extinguish, suppress and/or prevent fires.

### CROSS-REFERENCE TO RELATED APPLICATIONS

This application claims the benefit under 35 U.S.C. § 119(e) of U.S. Provisional Application Ser. No. 63/143,069, filed on Jan. 29, 2021, the entire disclosure of which is incorporated herein by reference.

### FIELD

The present application pertains to the field of firefighting agents. More particularly, the present application relates to water-enhancing, fire suppressing and/or fire-retarding hydrogels containing lignin, compositions used to form such hydrogels, and methods of fighting fires using such hydrogels.

### BACKGROUND

Fire is a threat to life, property, and natural, suburban, and urban landscapes worldwide. Forest, brush, and grassland fires destroy acres of natural and suburban landscapes each year; with the total average of acres lost to wildfire increasing since about 1984. This destruction is not only in terms of a loss of timber, wildlife and livestock, but also in erosion, disruption to watershed equilibria, and related problems in natural environments. In suburban, urban, and industrial areas, fire can result in billions of dollars in damage from loss of lives, property, equipment, and infrastructure; not only from the fire itself, but also from water used to extinguish it.

Fire and its constructs are often described by the “Fire Tetrahedron”, which defines heat, oxygen, fuel, and a resultant chain reaction as the four constructs required to produce fire; removing any one will prevent fire from occurring. There are five classes of fire: Class A, which comprises common combustibles, such as wood, cloth, etc.; Class B, which comprises flammable liquids and gases, such as gasoline, solvents, etc.; Class C, which comprises live electrical equipment, such as computers, etc.; Class D, which comprises combustible metals, such as magnesium, lithium, etc.; and, Class K, which comprises cooking media, such as cooking oils and fats.

Water remains a first line of defence against certain classes of fires (e.g., class A). However, there are disadvantages to using water to fight fire and/or prevent it from spreading to nearby structures. Often, most of the water directed at a structure does not coat and/or soak into the structure itself to provide further fire protection, but rather is lost to run off and wasted; what water does soak into a structure is usually minimal, providing limited protection as the absorbed water quickly evaporates. Further, water sprayed directly on a fire tends to evaporate at the fire's upper levels, resulting in significantly less water penetrating to the fire's base to extinguish it.

Consequently, significant manpower and local water resources can be expended to continuously reapply water on burning structures to extinguish flames, or on nearby structures to provide fire protection.

To overcome water's limitations as a fire-fighting resource, additives have been developed to enhance water's capacity to extinguish fires. Some of these additives include water-swellable polymers, or “super absorbent polymers,” such as cross-linked acrylic or acrylamide polymers, often found in diapers, that can absorb many times their weight in water, forming gel-like particles. Once dispersed in water, these water-logged particles can be sprayed directly onto a fire, reducing the amount of time and water necessary for fighting fires, as well as the amount of water run off (for example, see U.S. Pat. Nos. 7,189,337 and 4,978,460).

Other additives include acrylic acid copolymers cross-linked with polyether derivatives, which are used to impart thixotropic properties on water (for examples, see U.S. Pat. Nos. 7,163,642 and 7,476,346). Such thixotropic mixtures thin under shear forces, allowing them to be sprayed from hoses onto burning structures or land; once those shear forces are removed, the mixture thickens, allowing it to cling to, and coat, surfaces, extinguish flames, and prevent fire from spreading, or the structure from re-igniting.

Fire-retardant additives that are applied together with water to coat materials in the path of a fire have also been developed. Such retardants better prevent the spread of fire than the use of water alone. When used for fighting wildfires, such additives often include ammonium phosphates, and in particular ammonium polyphosphates. When heated, the ammonium polyphosphate additives release ammonia and phosphoric acid. The phosphoric acid reacts with carbon-based poly-alcohols, such as cellulose, to form esters, which then decompose upon further heating to release CO₂. The acid is reformed in the decomposition process and can recombine with further carbon-based poly-alcohols to repeat the process. The generated CO₂ acts to smother the flame and limit the ability of the source of the cellulosic materials to burn.

Fire-fighting additives such as those described above, however, suffer drawbacks. Additives that comprise such acrylic acid or acrylamide homo- or copolymers are not naturally sourced and are not readily biodegradable. Although these polymeric additives may sometimes be characterized as being biodegradable, they take a very long time to degrade and can persist in the environment following their use during firefights. In addition, because of their water absorbing capacity, they are very difficult to clean up after use, and can create a slippery environment when wet. Furthermore, concentrations of these additives in existing firefighting liquid and powder products are higher than the non-toxic thresholds identified by various environmental and health agencies.

For additives that comprise ammonium polyphosphates, the aforementioned chemistry is limited to surfaces that contain organic matter and is destructive to the structure of such surfaces. Further, the off-gassing vapours, particularly ammonia, may create concerns for individuals such as firefighters near the site of application. The released ammonia may also be harmful to aquatic life, thus posing concerns related to run off into bodies of water, such as rivers and lakes.

Despite advances in the field, there remains a need for environmentally friendly firefighting compositions made from water-enhancing additives that are naturally sourced and/or consumer grade, which are non-toxic and/or readily biodegradable, that can be used to suppress and/or retard fire.

### SUMMARY OF THE INVENTION

In one aspect, there is provided a composition comprising: (a) at least one lignin; and (b) at least one polymeric thickening agent, wherein mixture of said composition with water or an aqueous solution forms a fire suppressing and/or fire-retarding hydrogel.

In another aspect, there is provided a hydrogel, comprising: 0.1-30 wt % of the composition described herein; and 70-99.9 wt % of water or an aqueous solution, wherein the hydrogel is a fire-suppressant and/or fire retardant, useful for one or more of fire-fighting, fire-suppression, and fire-prevention.

In another aspect, there is provided a method of fighting a fire, comprising applying the hydrogel as described herein to active fire and/or areas surrounding the active fire.

### DETAILED DESCRIPTION

The present inventors have developed compositions that can be used to generate effective fire-suppressing and/or fire-retarding hydrogels. As detailed below, the presently disclosed compositions have been formulated to comprise at least one lignin and at least one polymeric thickening agent. The present inventors have surprisingly found that compositions comprising at least one lignin and at least one polymeric thickening agent, when exposed to water or an aqueous solution, form hydrogels that have surface adhesion and heat absorbing capabilities suitable for firefighting.

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

As used herein, whether in the specification or the appended claims, the transitional terms “comprising”, “including”, “having”, “containing”, “involving”, and the like are to be understood as being inclusive or open-ended (i.e., to mean including but not limited to), and they do not exclude unrecited elements, materials or method steps. Only the transitional phrases “consisting of” and “consisting essentially of”, respectively, are closed or semi-closed transitional phrases with respect to claims and exemplary embodiment paragraphs herein. The transitional phrase “consisting of” excludes any element, step, or ingredient which is not specifically recited. The transitional phrase “consisting essentially of” limits the scope to the specified elements, materials or steps and to those that do not materially affect the basic characteristic(s) of the invention disclosed and/or claimed herein.

It is to be understood that any numerical value inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Unless indicated to the contrary, the numerical parameters set forth in the present disclosure and attached claims are approximations that can vary as desired. At the very least, each numerical parameter should at least be construed in light of the number of reported significant digits and by applying ordinary rounding techniques.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, the term “biopolymer” refers to a polymeric substance occurring in living organisms (e.g., animals, plants, algae, and bacteria) while the term “biopolymeric” describes a substance that is a biopolymer.

As used herein, the term “thickening agent” refers to a substance used to increase the viscosity of liquid mixtures and solutions.

As used herein, a lignin “derivative” is a lignin that is generated by modifying a native lignin or a lignin obtained from a known process (e.g. kraft processing, sulfite processing, etc.) with, for example, a reactive functional group or molecular entity that promotes the formation of secondary/intermolecular interactions.

As used herein, the term “consumer-grade components” refers to food-grade, personal care-grade, and/or pharmaceutical-grade components. The term “food-grade” is used herein to refer to materials safe for use in food, such that ingestion does not, on the basis of the scientific evidence available, pose a safety risk to the health of the consumer. The term “personal care-grade” is used herein to refer to materials safe for use in topical application such that, topical application does not, on the basis of the scientific evidence available, pose a safety risk to the health of the consumer. The term “pharmaceutical-grade” is used herein to refer to materials safe for use in a pharmaceutical product administered by the appropriate route of administration, such that administration does not, on the basis of the scientific evidence available, pose a safety risk to the health of the consumer. As would be well understood by a person skilled in the art, the consumer-grade components in a composition provided herein are present at levels that would be acceptable for use in food, personal-care products and/or pharmaceuticals.

As used herein, the term “non-toxic” is intended to refer to materials that are non-poisonous, non-hazardous, and not composed of poisonous materials that could harm human health if exposure is limited to moderate quantities and not ingested. Non-toxic is intended to connote harmlessness to humans and animals in acceptable quantities if not ingested and even upon ingestion, does not cause immediate serious harmful effects to the person or animal ingesting the substance. The term non-toxic is not intended to be limited to those materials that are able to be swallowed or injected or otherwise taken in by animals, plants, or other living organisms. The term non-toxic may mean the substance is classified as non-toxic by the Environmental Protection Agency (EPA), the World Health Organization (WHO), the Food and Drug Administration (FDA), the United States Department of Agriculture (USDA), Health Canada, or the like. The term non-toxic is therefore not meant to mean non-irritant or not causing irritation when exposed to skin over prolonged periods of time or otherwise ingested.

When used to describe a hydrogel-forming composition or the resultant fire-suppressing and/or fire-retarding hydrogel of the present application, the term non-toxic indicates that the composition is non-toxic to humans at concentrations and exposure levels required for effective use as fire-fighting, suppressing, and/or preventing agents, without the need for protective gear.

As used herein, the term “biodegradable” is intended to refer to a substance that can be degraded or decomposed by the action of a living organism such as plants, algae, bacteria, or fungi. The degradation of a substance could be the substance being broken down physically into smaller pieces or chemically into constituent molecules. The constituent molecules of a biodegradable substance may or may not be metabolised by a living organism such as plants, algae, bacteria or fungi.

The term “room temperature” is used herein to refer to a temperature in the range of from about 20° C. to about 30° C.

The term “surface abrasion(s)” as used herein refers to any deviation from a surface's structural norm, such as, but not limited to, holes, fissures, gaps, gouges, cuts, scrapes, cracks, etc.

As used herein, the term “surface adhesion” refers to the ability of a composition to coat and/or adhere to a surface at any orientation (e.g., vertical cling). In referring to the hydrogel compositions of the present application, the term “surface adhesion” further refers to the ability of the hydrogel to adhere to a surface such that adequate firefighting, suppression, and/or protection is afforded as a result of the surface being coated by the hydrogel.

Hydrogel-Forming Compositions and their Components

In accordance with some embodiments, a hydrogel-forming composition provided herein may be a liquid concentrate comprising at least one lignin and at least one polymeric thickening agent. The liquid concentrate may be, for example, a solution, a suspension or a slurry. In some embodiments, the liquid concentrate includes less than about 5 wt % water, or less than about 3 wt % water, or less than about 2 wt % water, or less than about 1 wt % water.

In accordance with some embodiments, a hydrogel-forming composition provided herein may comprise additional property modifying additives, as described herein.

In accordance with some embodiment, a hydrogel-forming composition provided herein may comprise about 10 to about 75 wt % of a combination of the at least one lignin and the at least one polymeric thickening agent, for example, about 10 to about 65 wt % of the combination, about 10 to about 55 wt % of the combination, about 10 to about 45 wt % of the combination, about 20 to about 45 wt % of the combination, about 20 to about 40 wt % of the combination, about 25 to about 40 wt % of the combination, or about 30 to about 40 wt % of the combination.

In accordance with some embodiments, a hydrogel-forming composition provided herein may comprise the at least one lignin and at least one polymeric thickening agent in a ratio (at least one lignin:at least one polymeric thickening agent) measured in terms of the wt % of each component comprised in the composition, of between about 1:1 and about 1:20, for example, between about 2:3 and about 1:15, or between about 1:2 and about 1:12.

In accordance with some embodiments, a hydrogel-forming composition provided herein may comprise >75% non-toxic, consumer-grade components. In accordance with some embodiments, the components of the composition are biodegradable, renewable and/or naturally-sourced. For example, a composition described herein may comprise >80%, >85%, >90%, >95% or >98% non-toxic, consumer-grade components.

In accordance with some embodiments, at least 75%, by weight, of the components of a hydrogel-forming composition provided herein are on the GRAS (Generally Recognized as Safe) list maintained by the U.S. Food and Drug Administration. For example, a composition provided herein may comprise >80%, >85%, >90%, >95% or >98%, by weight, GRAS list components.

In some embodiments, at least 75%, by weight, of the components of a hydrogel-forming composition provided herein are food-grade. For example, a composition provided herein may comprise >80%, >85%, >90%, >95% or >98%, by weight, food-grade components.

In accordance with some embodiments, a hydrogel-forming composition provided herein may have a viscosity of from about 400 to about 1400 cPs, for example, when measured using a Brookfield LVDVE viscometer with a CS-34 spindle at 30 RPM, and/or a viscosity of from about 350 to about 1100 cPs, for example, when measured using a Brookfield LVDVE viscometer with a CS-34 spindle at 60 RPM.

### Lignins

Hydrogel-forming compositions provided herein comprise at least one lignin.

Lignins form a class of highly abundant, cross-linked phenolic biopolymers that are key structural materials in the support tissues of vascular plants and some algae. The composition of each lignin is influenced by the species and its environment. Chemically, the structure of lignins consist, generally, of phenylpropane units, originating from three aromatic alcohol precursors (monolignols): p-coumaryl, coniferyl and sinapyl alcohols. Lignins may also contain a variety of functional groups, including hydroxy, methoxy, carbonyl and carboxyl groups.

Lignins are extracted from lignocellulosic materials using physical, chemical and/or biochemical treatments. Different extraction processes may lead to lignins with varying structures and/or properties, for example, different hydrophobicities/hydrophilicities. Exemplary lignin extraction processes include, but are not limited to, kraft processing (kraft lignins), sulfite processing (lignosulfonates), hydrolysis (hydrolysis lignins), solvent processing (organosolv lignins) and soda processing (soda lignins).

Kraft processing extracts lignins from lignocellulosic materials using a mixture of chemicals, including sodium hydroxide (NaOH) and sodium sulphide (Na₂S) (White Liquor), which breaks bonds linking lignin to cellulose and hemi-cellulose. Kraft lignins are often characterized by relatively low sulfur contents, for example below 2 to 3%, high amounts of condensed structures, high levels of phenolic hydroxyl groups, and a generally low number average molar mass (Mn), for example between 1000 and 3000 g/mol.

Sulfite processing extracts lignins from lignocellulosic materials using aqueous sulfur dioxide (SO₂) and a base, for example a calcium, sodium, magnesium or ammonium base. Lignosulfonates are generally characterized as having a considerable amount of sulfur in the form of sulfonate groups present on aliphatic side chains of the lignosulfonate, being water-soluble, having a higher average molar mass than kraft lignin, and a broad polydispersity index, for example around 6 to 8. Cations used during pulp production and recovery may be retained in lignosulfonates generated using the sulfite process, and the identity and quantity of the retained cations may impact the reactivity of the lignosulfonate. For example, calcium- and ammonium-based products often exhibit the lowest and the highest reactivity, respectively, of the lignosulfonates, while sodium- and magnesium-based lignosulfonates show a medium reactivity.

Organosolv processing extracts lignins from lignocellulosic materials using solvent, for example acetone, methanol, ethanol, butanol, ethylene glycol, formic acid, and acetic acid. Organosolv lignins are recovered from the solvent used in the extraction by precipitation, which typically involves adjusting different parameters, such as concentration, pH and temperature. Known organosolv processes include the Alcell process, which is based on ethanol/water pulping and pulping with acetic acid, containing a small amount of mineral acid such as hydrochloric or sulfuric acid, as well as the Compagnie Industrielle de la Materière Végétale process (CIMV Company (France)), which is based on the use of a mixture of formic acid, acetic acid and water (Bio-lignin©). Organosolv lignins tend to show high solubility in organic solvents and little to no solubility in water (i.e. they are hydrophobic).

Soda processing extracts lignin from lignocellulosic materials using soda or soda-anthraquinone pulping processes which hydrolytically cleave bonds in the native lignin resulting in a relatively chemically unmodified lignin. An exemplary soda extraction process is the Granit process, where the pH value of the liquor is lowered by acidification, typically with mineral acids.

Hydrolysis lignins (H-lignins) are generally obtained as a coproduct from lignocellulosic-biorefineries. Such lignins are often generated together with other carbohydrate components of lignocellulosic materials, for example celluloses, during hydrolytic (pre)treatment of biomass, which may include the use of enzymes (i.e. enzymatic hydrolysis). Lignin may be recovered from the solution by precipitation. H-lignins generally maintain the original structure and chemical characteristics of native lignin and contain little inorganic impurities (e.g. are sulfur free).

One method of forming hydrolysis lignins is described in WO 2011/057413. The process described in WO 2011/057413 may include steps of i) mechanically refining lignocellulosic biomass under mild refining conditions to form a refined biomass pulp, ii) extracting a hemicellulose fraction from the refined biomass pulp to leave a residual pulp containing lignin, iii) hydrolysing carbohydrates in the residual pulp to sugars, iv) separating a high-quality lignin fraction from the sugars, iv) fermenting said sugars to form biofuels, such as ethanol and butanol, and v) recovering the hemicellulose fraction and the sugar alcohol as value-added products.

As described in WO 2011/057413, mechanical refining is a process employed to produce mechanical pulp where the biomass raw materials are separated into fibres by a combination of heat and mechanical force, and may include several variations, including refiner mechanical pulping (RMP), thermomechanical pulping (TMP), chemithermomechanical pulping (CTMP) and chemimechanical pulping (CMP).

Lignins obtained from any of the foregoing processes may be further functionalized/derivatized (i.e. may be converted to lignin “derivatives”). Such lignin derivatives may have alternative properties, for example be more or less hydrophobic, than the lignin modified to arrive at the lignin derivative. Such lignin derivatives may also interact with other reagents in a manner different than the lignin modified to arrive at the lignin derivative.

Methods for functionalizing lignins are well known and can be readily identified and carried out by a person of ordinary skill in the art. For example, lignins may be modified by adding reactive functional groups, such as phenols (by “phenolation”), acrylates, epoxies, amines, vinyl, etc.; or by modification with molecular entities that promote the formation of secondary/intermolecular interactions, such as hydrogen bonds, ionic interactions, etc.

In accordance with some embodiments, a hydrogel-forming composition provided herein comprises a kraft lignin, a lignosulfonate, an organosolv lignin, a soda lignin, a hydrolysis lignin, a derivative thereof, or a mixture thereof as the at least one lignin. In some embodiments, the hydrolysis lignin is produced by a process comprising mechanically refining lignocellulosic biomass, enzymatic hydrolysis of the mechanically refined lignocellulosic biomass and, optionally, functionalization of the hydrolyzed lignocellulosic biomass. In some embodiments, mechanically refining the lignocellulosic biomass comprises mechanical pulping (RMP), thermomechanical pulping (TMP), chemithermomechanical pulping (CTMP) or chemimechanical pulping (CMP), preferably TMP. In some embodiments, the process further comprises functionalizing the hydrolyzed lignocellulosic biomass. In some embodiments, the process used to produce the hydrolysis lignin produces cellulosic sugars concomitantly with the hydrolysis lignin.

Lignins may be formed in varying sizes. In accordance with some embodiments, the at least one lignin has an average particle size of no greater than 500 nm, for example, no greater than 400 nm, no greater than 300 nm, no greater than 200 nm, no greater than 100 nm, no greater than 50 nm, no greater than 10 nm, or no greater than 5 nm.

### Polymeric Thickening Agents

Hydrogel-forming compositions provided herein comprise at least one polymeric thickening agent in addition to the at least one lignin. Such polymeric thickening agents include, but are not limited to, biopolymeric thickening agents and non-biopolymeric thickening agents.

In accordance with some embodiments, a hydrogel-forming composition provided herein comprises at least one biopolymeric thickening agent, at least one non-biopolymeric thickening agent, or a mixture thereof.

Polymeric thickening agents used in the hydrogel-forming compositions provided herein may be selected such that they interact with the at least one lignin in a specific manner. In accordance with some embodiments, the at least one lignin interacts with the at least one polymeric thickening agent via one or more intermolecular forces, for example, via ionic interactions, hydrogen bonding, van der Waals forces, or a mixture thereof. In some embodiments, the at least one lignin interacts with the at least one polymeric thickening agent via ionic interactions. In some embodiments, the at least one lignin interacts with the at least one polymeric thickening agent via hydrogen bonding. In some embodiments, the at least one lignin interacts with the at least one polymeric thickening agent via van der Waals forces.

Biopolymeric Thickening Agents

Hydrogel-forming compositions provided herein may comprise at least one biopolymeric thickening agent. Within the context of the present application, suitable biopolymeric thickening agents are selected to provide hydrogels with surface adhesion and heat absorbing capabilities effective for abating, extinguishing, and/or preventing fires.

While lignins are biopolymeric materials that may also function as thickening agents, as used herein, the term biopolymeric thickening agent does not encompass lignins.

Certain polysaccharides can function as biopolymeric thickening agents. Polysaccharide thickening agents include, for example, starches, sugar polymers and natural gums.

Certain proteins can also function as thickening agents. Protein thickening agents include, for example, collagen, gelatin, gluten, soy protein, milk protein, and corn protein.

In accordance with some embodiments, the biopolymeric thickening agents may be a polysaccharide or a protein.

In accordance with some embodiments, the polysaccharide is starch. In some embodiments, the starch is present in the range of 0-50 wt %, 3-30 wt %, or 3-15 wt % of the components of the composition.

Starch, which is a biodegradable, naturally-sourced polysaccharide, can form gels in the presence of water and heat. Starch-based hydrogels can act as fire retardants due to their high water retaining and surface-adhesion capabilities [loanna G. Mandala (2012). Viscoelastic Properties of Starch and Non-Starch Thickeners in Simple Mixtures or Model Food, Viscoelasticity—From Theory to Biological Applications, Dr. Juan De Vicente (Ed.), ISBN: 978-953-51-0841-2, InTech, DOI: 10.5772/50221. Available from: http://www.intechopen.com/books/viscoelasticity-from-theory-to-biological-applications/viscoelastic-properties-of-starch-and-non-starch-thickeners-in-simple-mixtures-or-model-food]. Examples of starches that are viable for use in compositions provided herein include, but are not limited to, corn starch, wheat starch, arrowroot, potato starch, tapioca, and/or rice starch, or consumer-grade derivatives thereof, which may or may not be naturally sourced. Starches can be modified by cross-linking, pregelatinizing, hydrolysis, acid/base-treating, or heating to modify their structure, leading to alteration of their solubility, swelling, viscosity in solution, or stability.

In accordance with some embodiments, the polysaccharide is a polysaccharide gum, such as, but not limited to, guar gum, xanthan gum, acacia gum (gum arabic), diutan gum, welan gum, gellan gum, and/or locust bean gum, and/or derivatives thereof, some of which are used as thickeners in food, pharmaceutical and/or cosmetic industries. In some embodiments, the polysaccharide gum is present in the range of 5-90 wt %, 10-60 wt %, or 15-30 wt % of the components of the composition. Polysaccharide gums are polymers of various monosaccharides with multiple branching structures that cause a large increase in the viscosity of a solution. For example, guar gum is a branched polymer of a linear mannose polymer with galactose side-branches, sourced primarily from ground endosperms of guar beans, and reportedly has a greater water-thickening potency than cornstarch; xanthan gum is produced by Xanthomonas camperstris [Tako, M. et al. Carbohydrate Research, 138 (1985) 207-213]; and acacia gum is a branched polymer of arabinose and galactose monosaccharides.

Other polysaccharides can also function as thickening agents, including, for example, agar, sodium alginate, cellulose and derivatives thereof (such as carboxymethylcellulose, hydroxyethylcellulose and hydroxypropylcellulose), pectin, and carrageenan. In some embodiments, cellulose and derivatives thereof may be present in the range of 0-50 wt %, 10-40 wt %, or 15-30 wt % of the components of the composition. Like starch, cellulose derivatives have multiple thermally induced structural transitions that require energy, and thus may act as a heat sink when used in a fire-suppressing and/or fire-retarding hydrogel. An example of a cellulosic, hydrogel-forming thickening agent is carboxymethylcellulose, which has found use in personal lubricants, toothpastes, and ice creams as a thickener; it is food-grade and biodegradable, and can absorb water at concentrations as low as 1% in water.

In accordance with some embodiments, a hydrogel-forming composition provided herein may comprise a combination of biopolymeric thickening agents, for example, the composition may comprise a mixture of two or more polysaccharide gums, or a mixture of at least one starch and at least one polysaccharide gum (for example, two or more polysaccharide gums). In some embodiments, a composition provided herein comprises a blend of xanthan gum, guar gum and corn starch (for example, having a gum:starch ratio from 1:1 to 5:1 and a xanthan gum:guar gum ratio of from 1:1 to 3:1); or a blend of xanthan gum, acacia gum and corn starch (for example, having a gum:starch ratio from 1:1 to 5:1 and a xanthan gum:acacia gum ratio of from 1:1 to 3:1); or a blend of acacia gum, guar gum and corn starch (for example, having a gum:starch ratio from 1:1 to 5:1 and a acacia gum:guar gum ratio of from 1:1 to 3:1). In some embodiments, the composition comprises at least one polysaccharide gum and at least one cellulosic polymer (for example, having a gum:cellulosic polymer ratio from 1:1 to 5:1). In some embodiments, the composition comprises two or more polysaccharide gums, and at least one cellulosic polymer, such as xanthan gum, guar gum and hydroxypropylcellulose (for example, having a gum:cellulosic polymer ratio from 1:1 to 5:1 and a xanthan gum:guar gum ratio of from 1:1 to 3:1). In some embodiments, the composition comprises at least one starch, at least one polysaccharide gum, and at least one cellulosic polymer, such as corn starch, xanthan gum, and hydroxyethylcellulose (for example, having a polysaccharide:cellulosic polymer ratio from 1:1 to 5:1 and a gum:starch ratio of from 1:1 to 3:1). In some embodiments, the composition comprises at least one starch, two or more polysaccharide gums, and at least one cellulosic polymer (for example, having a polysaccharide:cellulosic polymer ratio from 1:1 to 5:1 and a gum:starch ratio of from 1:1 to 3:1).

Non-Biopolymeric Thickening Agents

Hydrogel-forming compositions provided herein may comprise at least one non-biopolymeric thickening agent. Within the context of the present application, suitable non-biopolymeric thickening agents are selected to provide hydrogels with surface adhesion and heat absorbing capabilities effective for abating, extinguishing, and/or preventing fires.

In accordance with some embodiments, the non-biopolymeric thickening agent may comprise a cross-linked, water-swellable polymer. In some embodiments, the composition comprises a co-polymer of hydrophilic monomers, such as acrylamide, acrylic acid derivatives, maleic acid anhydride, itaconic acid, 2-hydroxyl ethyl acrylate, polyethylene glycol dimethacrylate, allyl methacrylate, tetraethyleneglycol dimethacrylate, triethyleneglycol dimethacrylate, diethylene glycol dimethacrylate, glycerol dimethacrylate, hydroxypropyl methacrylate, 2-hydroxyethyl methacrylate, 2-tert-butyl aminoethyl methacrylate, dimethylaminopropyl methacrylamide, 2-dimethylaminoethyl methacrylate, hydroxypropyl acrylate, trimethylolpropane trimethacrylate, 2-acrylamido-2-methylpropanesulfonic acid derivatives, and other hydrophilic monomers. In some embodiments, the composition comprises a cross-linked polyacrylic acid; a cross-linked, partially neutralized polyacrylic acid; a cross-linked, fully neutralized polyacrylic acid; or a combination thereof. In some embodiments, the composition comprises an acrylic acid copolymer cross linked with a polyalkenyl polyether.

In accordance with some embodiments, a hydrogel-forming composition provided herein may comprise polyvinyl alcohol, polyvinyl acetate, polyethylene oxide, polypropylene oxide and polyvinylpyrolidone, and the like, as a non-biopolymeric thickening agent. In some embodiments, the composition comprises a polymer comprising an acrylic acid, an acrylamide, a vinyl alcohol, a derivative thereof, or a mixture thereof.

In accordance with some embodiments, a hydrogel-forming composition provided herein may comprise a co-polymer of acrylamide and acrylic acid derivatives as a non-biopolymeric thickening agent. In some embodiments, the composition comprises a polymer of at least one of a salt of acrylate and acrylamide. In some embodiments, the composition comprises a terpolymer of a salt of acrylate, acrylamide, and a salt of 2-acrylamido-2-methylpropanesulfonic acid (AMPS). The salts may be sodium salts.

In accordance with some embodiments, a hydrogel-forming composition provided herein may comprise a polymer selected from a group of polymers known by their trade designation CARBOPOL™ (generally high molecular weight homo- and copolymers of acrylic acid cross-linked with a polyalkenyl polyether) as a non-biopolymeric thickening agent. Such a polymer may be CARBOPOL™ EZ-3, a hydrophobically modified cross-linked polyacrylate powder that is self-wetting, can require low agitation for dispersion, and has a shear thinning rheology, so can be pumped or sprayed onto a surface without the loss of cling.

In accordance with some embodiments, a non-biopolymeric thickening agent may be capable of absorbing at least 20 times its own weight of water.

In accordance with some embodiments, a hydrogel-forming composition provided herein may comprise a combination of at least one biopolymeric thickening agent and at least one non-biopolymeric thickening agent, for example, two or more biopolymeric thickening agent and one or more non-biopolymeric thickening agent. In some embodiments, the non-biopolymeric thickening agent(s) swells at a faster rate when mixed with water, or an aqueous solution than the biopolymeric thickening agent(s) comprised in the hydrogel-forming composition. Without being limited by any particular theory, it is expected that the faster swelling rate of the non-biopolymeric thickening agent may reduce water evaporation as the hydrogel is applied to a fire.

### Fire Retardants

Hydrogel-forming compositions provided herein may comprise at least one fire retardant additive. As used herein, the term fire retardant additive does not include a lignin.

Fire retardant additives are well-known and include, for example, alumina trihydrate, magnesium hydroxide, huntite, hydromagnesite, ammonium polyphosphates, ammonium phosphates, ammonium sulfates, and the like. Exemplary ammonium phosphates include, but are not limited to, ammonium orthophosphates, such as monoammonium orthophosphate (MAP) and diammonium orthophosphate (DAP), ammonium pyrophosphates, and the like. Exemplary ammonium polyphosphates include, but are not limited to ammonium tripolyphosphates, ammonium tetrapolyphosphates, etc., and the like. Alkaline earth substituted versions of ammonium polyphosphates and ammonium phosphates may also be fire retardant additives.

Ammonium polyphosphates are inorganic salts of polyphosphoric acid and ammonia comprising [NH₄PO₃] monomer units, and are well-known fire retardants Ammonium polyphosphates may be a straight chain or branched, and their properties depend on, for example, the number of monomer units (n) contained in the polymer and the degree of branching of the polymer Ammonium polyphosphates with long chain lengths, for example where n>1000, are known as high molecular weight ammonium polyphosphates, while ammonium polyphosphates with shorter chain lengths, for example where n<100, are known as low molecular weight ammonium polyphosphates Ammonium polyphosphates may crystallize in different forms, for example as crystalline form I or crystalline form II ammonium polyphosphate.

In accordance with some embodiments, a hydrogel-forming composition provided herein may comprise a fire retardant additive, such as alumina trihydrate, magnesium hydroxide, huntite, hydromagnesite, at least one ammonium polyphosphate, at least one ammonium phosphate, at least one ammonium sulfate, or a mixture thereof. In some embodiments, the composition comprises at least one high molecule weight ammonium polyphosphate, at least one low molecular weight ammonium polyphosphate, at least one ammonium phosphate, at least one ammonium sulfate or a mixture thereof. In some embodiments, the composition comprises at least one high molecule weight ammonium polyphosphate, at least one low molecular weight ammonium polyphosphate, or a mixture thereof. In some embodiments, the composition comprises a low molecular weight ammonium polyphosphate, wherein n<20. In some embodiments, the composition comprises at least one ammonium polyphosphate having crystal form I, at least one ammonium polyphosphate having crystal form II, or a mixture thereof.

### Liquid Medium

Hydrogel-forming compositions provided herein may be a liquid suspension. Suspending the components of the hydrogel-forming composition in a liquid medium facilitates its mixing with water, and potentially increases the rate and/or ease at which a hydrogel is formed for use to extinguish, suppress, and/or protect against fire. Examples of non-toxic, consumer-grade liquid mediums include, but are not limited to, edible oils (such as nut/seed oils or vegetable/plant oils), petroleum distillates (e.g., mineral oil, such as liquid paraffin oil), glycerol, glycols (e.g., ethylene glycol or propylene glycol), low molecular weight polyethylene glycol (PEG), polyolefins (e.g., polybutene or polyisobutylene), siloxane, terpenes (e.g., squalene or squalene), and carbohydrate-derived liquids (e.g., maltooligosyl glucoside or hydrogenated starch hydrolysate), with or without a small amount of water (for example, 5% or less, by weight, or from about 1% to about 3% by weight).

In addition to being naturally-sourced and/or food-grade, liquid mediums such as vegetable oil, glycerol, and PEG resist freezing at sub-zero temperatures; thus, compositions formed with such liquid mediums can maintain their utility for forming hydrogels under winter and/or arctic conditions. Further, some liquid mediums, such as glycerol, glycols, and PEG, are water-miscible, which can also enhance the ability of the concentrate to efficiently mix with water or an aqueous solution and form a hydrogel. Liquid mediums that do not comprise an ester or ketone moiety may be inert to non-metallic (e.g., chlorinated polyvinyl chloride (CPVC)) pipe and/or fittings.

In accordance with some embodiments, a hydrogel-forming composition provided herein comprises at least one liquid medium. In some embodiments, the composition comprises a mixture of more than one liquid media. In some embodiments, the liquid medium comprises canola oil. In some embodiments, the canola oil is used in combination with water. In some embodiments, the canola oil is used in combination with castor oil, for example, in a 1:1 mixture.

The amount of liquid medium present in a hydrogel-forming composition provided herein may vary depending on the quantity and identity of other components of the composition.

In accordance with some embodiments, the liquid medium is present in the composition in a range of from about 35% to about 80%, by weight, for example, from about 40% to about 70%, by weight, from about 50% to about 70%, by weight, from about 55% to about 70%, by weight, from about 60% to about 70%, by weight, or from about 60% to about 65%, by weight.

### Additives

Other components, or additives, can be added to hydrogel-forming compositions provided herein in order to affect or alter one or more properties of the compositions or the hydrogels formed from the compositions. The appropriate additive(s) can be incorporated as required for a particular use. For example, additives can be added to affect the viscosity and/or stability of a hydrogel-forming composition provided herein, and/or the resultant hydrogel. Additional additives that can be incorporated in a hydrogel-forming composition provided herein and/or the resultant hydrogel include, but are not limited to, binding agents, pH modifiers, suspending agents (e.g., surfactants, emulsifiers, clays), salts, hydrogen-bonding disruptors (e.g., glucose, silica), stabilizers, preservatives, salts, sugars, freeze point depressants, anti-microbial agents, antifungal agents and pigments or dyes/coloring agents.

Specific, non-limiting examples of non-toxic, consumer-grade additives include: sodium and magnesium salts (e.g., borax, sodium bicarbonate, sodium sulphate, magnesium sulphate, sodium chloride), which can affect hydrogel viscosity and/or stability [Kesavan, S. et al., Macromolecules, 1992, 25, 2026-2032; Rochefort, W. E., J. Rheol. 31, 337 (1987)]; chitosan or epsilon polylysine, which can act as anti-microbials [Polimeros: Ciencia e Tecnologia, vol. 19, no 3, p. 241-247, 2009; http://www.fda.gov/ucm/groups/fdagov-publia@fdagov-foods-gen/documents/document/ucm 267372.pdf (accessed Sep. 26, 2014)]; consumer-grade preservatives such as Proxel™ GXL, Froxel™ BD20, and potassium sorbate and salts thereof; citric acid for modifying pH; potassium acetate and sodium bicarbonate, which can help sequestering Class B (which comprises flammable liquids and gases, such as gasoline, solvents, etc.) or K (which comprises cooking media, such as cooling oils and fats) fires; and pectin, which can aid in the formation of hydrogels.

Suspending Agents

Hydrogel-forming compositions provided herein, formed from solid components (e.g., lignins, and biopolymeric thickening agents and/or non-biopolymeric thickening agents) suspended or dissolved in a liquid medium (e.g., a vegetable oil), may exhibit settling of solid components over time. If such settling were to occur, the hydrogel-forming composition can be physically agitated in order to re-suspend or re-dissolve its components.

Alternatively, a suspending agent (e.g., surfactant, emulsifier or clay), or a combination of suspending agents, can be added to the hydrogel-forming composition to stabilize it, or to facilitate keeping solid components suspended or dissolved in the liquid medium, either indefinitely, or for a length of time sufficient to maintain the hydrogel-forming compositions utility for forming hydrogels.

Suspending agents may improve the properties of hydrogels formed from the compositions provided herein as compared to those that do not include the agents, for example, by improving the speed at which hydrogels provided herein are formed and/or providing stability and flowability to the hydrogel-forming composition. The addition of a suspending agent (e.g., surfactant and/or emulsifier, or combination of surfactants and/or emulsifiers) to a hydrogel-forming composition, may also increase the viscosity of the hydrogel-forming composition and/or increase the viscosity of hydrogels employed in the methods described herein formed following dilution of the hydrogel-forming composition with water or an aqueous solution. While not wishing to be bound to any particular theory, it is believed that this effect of the suspending agent, or combination of suspending agents, occurs as a result of their suspension action, and/or by increasing the amount of material that can be included in a hydrogel-forming composition or hydrogels formed from the hydrogel-forming compositions.

Suspending agents suitable for use in hydrogel-forming compositions provided herein may be synthetic, naturally-occurring or organophilic, non-toxic, and, optionally, consumer-grade.

In accordance with some embodiments, a hydrogel-forming composition provided herein comprises at least one suspending agent. In some embodiments, the at least one suspending agent comprises at least one non-particulate suspending agent, at least one particulate suspending agent, or a mixture thereof.

Non-limiting examples of non-toxic, consumer-grade, non-particulate suspending agents that may be incorporated into a hydrogel-forming composition provided herein include lecithins (e.g., Metarin™), lysolecithins, polysorbates, sodium caseinates, monoglycerides, fatty acids, fatty alcohols, glycolipids, and/or proteins [Kralova, I., et al. Journal of Dispersion Science and Technology, 30:1363-1383, 2009]. Such suspending agents may be provided as solids or liquids.

Non-limiting examples of particulate suspending agents that may be incorporated into a hydrogel-forming composition provided herein include silica, glycogen particles, clays (e.g., bentonite) and organophilically modified clays (e.g., organically modified montmorillonite). In the case of silica, the silica can be an amorphous silica, such as a fumed silica (for example, an Aerosil®), which can be a hydrophobic fumed silica.

Hydrogel-forming compositions of the present application are designed to be stable (i.e., to not exhibit settling, stratification or crystallization) when stored for at least 30 days at room temperature. In accordance with some embodiments, the composition exhibits stability when stored at temperatures in the range of from about −20° C. to about 65° C., or at temperatures in the range of about 0° C. to about 45° C., for at least 30 days.

Further Additives

Hydrogel-forming compositions provided herein may also include a pH modifier. A pH modifier is any material capable of altering the pH when added. In accordance with some embodiments, the pH modifier is an acid that lowers the pH, such as organic acids (e.g. acetic, oxalic, or citric acid) or mineral acids (e.g. hydrochloric acid), or a base that increases the pH, such as organic bases (e.g. triethanolamine) or inorganic bases (e.g. sodium or ammonium hydroxide). In some embodiments, the pH modifier includes an alcohol amine neutralizer such as, for example, an amino-methyl-propanol (e.g., 2-amino-2-methyl-1-propanol).

Hydrogel-forming compositions provided herein may also include freeze point depressants. Freeze point depressants are used to prevent hydrogels formed from the hydrogel-forming compositions provided herein and/or the hydrogel-forming compositions themselves from freezing. Freeze point depressants include, but are not limited to, glycerol, propylene glycol, sugar, salt, and the like.

Hard water, i.e. water containing various levels of cations, may affect the degree of swelling of a polymer comprised in hydrogels formed from the hydrogel-forming compositions provided herein. In accordance with some embodiments, hydrogel-forming compositions provided herein may comprise a component to counteract this effect. In some embodiments, AMPS or a derivative of AMPS is added to counter the effect of hard water. One skilled in the art would recognize that the amount and nature of the component added may be varied depending on the hardness of the water used.

Cross-linking agents may be used to adjust the viscosity of hydrogels formed from the hydrogel-forming compositions provided herein and/or the hydrogel-forming compositions themselves. In accordance with some embodiments, hydrogel-forming compositions provided herein comprise a cross-linking agent. Suitable crosslinking agents include, but are not limited to, triethanolamine; alkali metal borates, such as sodium and potassium borates; alkali metal pyroantimonates, such as sodium and potassium pyroantimonates; titanates, such as sodium and potassium fluorotitanates and potassium titanium oxalate; chromates, such as sodium and potassium chromates and dichromates; vanadates, such as ammonium vanadate; and the like.

As would be readily appreciated by a worker skilled in the art, additive(s) can be added to a hydrogel-forming composition provided herein, or additive(s) can be added during formation of a hydrogel provided herein, or additive(s) can be added to a hydrogel provided herein. When an additive is added to a hydrogel-forming composition provided herein, the additive can be incorporated in the composition or can be added after composition formation.

Water-Enhancing, Fire-Suppressing and/or Fire-Retarding Hydrogels

The present application further provides water-enhancing, fire-suppressing and/or fire-retarding hydrogels formed from the hydrogel-forming compositions described above.

A water-enhancing, fire-suppressing and/or fire-retarding hydrogel can be formed by mixing a hydrogel-forming composition provided herein with water or an aqueous solution. The term “hydrogel” is used herein to refer to the gel-like material formed from mixing a composition provided herein in water. The hydrogel is an aqueous solution of most or all of the components of a hydrogel-forming composition provided herein, with any undissolved components present as a suspension in the hydrogel.

In accordance with some embodiments, hydrogels described herein comprise between about 0.01% and about 50% by weight of a hydrogel-forming composition provided herein, with the remainder being water or an aqueous solution. In some embodiments, hydrogels described herein comprise between about 0.1% and about 30%, by weight, of a hydrogel-forming composition provided herein, with the remainder being water or an aqueous solution. In some embodiments, hydrogels described herein comprise between about 1% and about 8% (e.g., between about 1% and about 3%, between about 2% and about 4%, or between about 3% and about 6%), by weight, of a hydrogel-forming composition, with the remainder being water or an aqueous solution.

The hydrogels described herein may be used to fight domestic, industrial, and/or wild fires by eliminating at least one construct of the “fire tetrahedron”. The hydrogels may be applied directly to an active fire to suppress the fire and/or be applied to structures, edifices and/or landscape elements in the area surrounding the active fire to prevent such structures, edifices and/or landscape elements from igniting and thus prevent the fire from spreading, i.e. the hydrogel may act as a retardant. In accordance with some embodiments, a hydrogel provided herein is for use in a method of fighting a fire. In some embodiments, the method comprises applying a hydrogel provided herein to active fire and/or areas surrounding the active fire. In some embodiments, the hydrogel is applied to burning or fire-threatened structures, such as edifices and/or landscape components (e.g., trees, bushes, fences) via firefighting equipment. In some embodiments, the hydrogels described herein are suitable for fighting Class A fires (i.e., wood and paper fires). In some embodiments, the hydrogels described herein are suitable for fighting Class B fires (i.e., oil and gas fires). In some embodiments, the hydrogels described herein are suitable for fighting wildland fires.

When applied using firefighting equipment, a hydrogel-forming composition provided herein is mixed with the equipment's water supply or mixed with water in a reservoir, and then applied to target objects (such as, structures, edifices and/or landscape elements) to extinguish, suppress, and/or prevent fire or to protect the target objects from fire. Using a hydrogel-forming composition provided herein, the hydrogel is often prepared in bulk, but can also be prepared using an appropriate on demand system, such as a solid phase educator (e.g., the dry inductor from Pattison, the Cleanload™ chemical inductor from Dultmeier, or a Handler™ chemical handling system from Polywest).

Firefighting equipment useful in applying hydrogels provided herein, comprises means for spraying, or otherwise applying, the resultant hydrogel onto the target objects. In accordance with some embodiments, the firefighting equipment additionally comprises a means for mixing a hydrogel-forming composition provided herein with water or an aqueous solution and a reservoir for holding the composition until required; the reservoir being in fluid communication with the mixing means such that the composition can be moved from the reservoir to the mixing means for mixing with the water or aqueous solution. In some embodiments, the firefighting equipment additionally comprises means for introducing water or an aqueous solution to the means for mixing, or a reservoir fluidly connected to the means for mixing, such that the water or aqueous solution can be moved from the reservoir to the mixing means for mixing with a hydrogel-forming composition provided herein.

Non-limiting examples of firefighting equipment suitable for application/deployment of the hydrogel prepared from a hydrogel-forming composition provided herein include fire extinguishers (e.g., an air over water extinguisher), spray nozzle-equipped backpacks, or sprinkler systems. The firefighting equipment can be mounted on or in a vehicle, such as, a truck, airplane or helicopter. In accordance with some embodiments, the hydrogel is applied using a single deployment means.

In accordance with some embodiments, in which a hydrogel provided herein is used for firefighting using fire trucks, or other firefighting vehicles, including aircrafts, the hydrogel is formed and used via the following, non-limiting process: a hydrogel-forming composition provided herein is added to a vehicle's water-filled dump tank and/or other portable tank, and mixed with the water via a circulating hose, or equivalent thereof; pumping the hydrogel, once formed, out of the tank(s), and applying the hydrogel to the target objects (e.g., edifices or landscape elements), via a hard suction hose, or equipment equivalent thereof.

In accordance with some embodiments, a hydrogel-forming composition provided herein is added directly to a vehicle's onboard water tank, either manually or via an injection system, and mixed by agitation with optional recirculation/overpumping in the tank. In one example of such an embodiment, the injection system comprises an ‘after the pump’ system that injects specified amounts of the composition into water that has passed through the vehicle's pump, and is about to enter the fire hose; friction of, or the shear forces caused by, the water moving through the hose assists in mixing the composition with the water to produce the hydrogel in the hose. In another specific example, the injection system pumps the composition from a dedicated reservoir to an injection pipe that introduces the composition into the water just prior to the hose line; a computerized system calculates water flow via a flow meter on said injection pipe to inject required amounts of the composition into the pipe and hose stream via a specially designed quill.

In accordance with some embodiments, a hydrogel-forming composition provided herein is metered into the water stream before the pump or proportioned via use of an educator (solid into liquid).

Fire-fighting vehicles suitably equipped with an in-line injection system, allow a composition provided herein to be added directly in-line with the water, which can then be mixed via physical agitation and/or shear forces within the hose itself.

As would be readily appreciated by a person skilled in the art, although the methods for hydrogel formation described above specifically refer to a firefighting truck, such methods are equally applicable to firefighting using aircraft, such as airplanes or helicopters, where the hydrogel is formed and then air dropped from the aircraft.

In accordance with some embodiments, a hydrogel is made from a hydrogel-forming composition provided herein at the time of firefighting using fire fighting backpacks. In such embodiments, the hydrogel-forming composition can be added to directly to the backpack's water-filled reservoir, and manually or mechanically shaken to form the hydrogel. Once formed, the hydrogel can be applied to requisite objects, or surfaces, via the backpacks' spray-nozzles.

In accordance with some embodiments, a hydrogel-forming composition provided herein can be added to a sprinkler system's water supply, such that, upon activation as a result heat, smoke, and/or fire detection, the system sprays the resultant hydrogel rather than simply water (as in current practice). In some embodiments, once a sprinkler system is activated, a dedicated pump system injects the composition into the sprinkler's water system, producing a hydrogel with properties compatible with the sprinkler's flow requirements, prior to being applied to an object or area (e.g., an edifice, room or landscape area). In some embodiments, the sprinkler system comprises sprinkler heads designed to provide an optimized spray pattern for applying a hydrogel to an object or area (e.g., an edifice, room or landscape area).

In accordance with some embodiments, a sprinkler system for applying hydrogels provided herein comprises: a dedicated pump for injecting a hydrogel-forming composition provided herein into the sprinkler's water system or for drawing the composition into the sprinkler system's water stream; a sprinkler head designed to provide an optimized spray pattern for hydrogel application; a computerized system to calculate water and/or hydrogel flow; a flow meter to detect water flow in dry pipes; and, a point of injection designed to introduce the composition into the water in such a way that is compatible with the sprinkler system and its intended use.

### Hydrogel Firefighting Properties

Hydrogels, as formed from hydrogel-forming compositions provided herein, are suitable for use as firefighting agents due to their physical and/or chemical properties. The hydrogels are more viscous than water, and generally resist evaporation, run-off, and/or burning when exposed to high temperature conditions (e.g., fire), due to their water-absorbing, viscosity-increasing components. These hydrogels also exhibit shear-thinning, thixotropic, pseudoplastic, and/or non-Newtonian fluidic behaviour, such that their viscosity decreases when they are subjected to stresses, such as, but not limited to, shear stresses, wherein their viscosity increases again when those stresses are removed. Consequently, once formed, the hydrogels provided herein can be sprayed via hoses and/or spray-nozzles onto burning objects (e.g., edifices or landscape elements) or objects in the path of the fire in a manner similar to water; and, once the hydrogels are no longer subjected to the stresses of being sprayed, their viscosity will increase to be greater than that of water. As a result, the hydrogels coat and cling, at virtually any angle, to surfaces they are applied to, allowing them to extinguish fires by displacing oxygen and cooling surfaces, prevent fire flash-over, and/or further protect surfaces from ignition and/or re-ignition via the hydrogels' general resistance to evaporation, run-off, and/or burning.

Further, as the viscosity increase would not be instantaneous, the hydrogels can ‘creep’ or ‘ooze’ into surface abrasions or structural gaps, such as, but not limited to, cracks, holes, fissures, etc., in an edifice or landscape element, coating and protecting surfaces that would otherwise be difficult to protect with water, or other firefighting agents such as foams, due to evaporation or run-off. This will contribute an element of penetrative firefighting to a firefighter's arsenal: once the hydrogel's viscosity has increased, it will form a protective layer in, on, under and/or around said cracks, surface abrasions, structural gaps or the like. Also, use of the herein described hydrogels can minimize water damage to surfaces, since use of the hydrogels would replace the direct use of water in firefighting.

In accordance with some embodiments, a hydrogel formed from a hydrogel-forming composition provided herein has a viscosity of from about 400 to about 1250 cPs when measured using a Brookfield LVDVE viscometer with a CS-34 spindle at 30 RPM, and/or a viscosity of from about 230 to about 800 cPs when measured using a Brookfield LVDVE viscometer with a CS-34 spindle at 60 RPM.

In one example, a hydrogel provided herein is applied at the head of an approaching fire, either as a fire break or to protect a property (e.g., cottage, house, or commercial or municipal building). Firefighters can proceed via “coat and approach” to protect firefighters inside a circumference set by a coating of the hydrogel, allowing the firefighters to create a protected route of egress.

Since many of the components of the hydrogel-forming compositions provided herein are water soluble, much of the resultant hydrogel is easily cleaned up after use, simply by using water. Further, as other components of the hydrogel-forming compositions provided herein are naturally sourced and/or biodegradable, there is little concern leaving them where they settle. For example, lignins are derived from the forestry industry; when hydrogel-forming compositions provided herein are used to suppress and/or retard wild fires, they return a component that may have been taken from the treated area.

To gain a better understanding of the invention described herein, the following examples are set forth. It should be understood that these examples are for illustrative purposes only. Therefore, they should not limit the scope of this invention in any way.

### EXAMPLES

### General Experimental

### Materials

The following reagents used in the preparation of the hydrogel-forming compositions were used as received from commercial suppliers: xanthan gum (food grade, PO #DW-456270, Univar, 17425 NE Union Hill Road, Redmond, Wash.; Bulk Barn Canada); guar gum (P.L.Thomas&Co.Inc., Head Quarters Plaza, Morristown, N.J.; Bulk Barn Canada); corn starch (Bulk Barn Canada); canola oil (FreshCo, Kingston, ON, Canada); ARBO SO1 P sodium lignosulfonate (Tembec, Temiscaming, Quebec, Canada); ARBO A02 ammonium lignosulfonate (Rayonier Advanced Materials, Temiscaming, Quebec, Canada); and hydrolysis lignin.

The following reagents were removed from shipping containers and dried on a bench top prior to use: Amallin Lignin A (West Fraser, 1250 Brownmiller Road, Quesnel, BC, Canada); and Amallin Lignin B (West Fraser, 1250 Brownmiller Road, Quesnel, BC, Canada).

### General Method for Producing Hydrogel-Forming Compositions

Hydrogel-forming compositions were composed of at least four types of materials: (1) lignins (e.g. lignosulfonates or kraft lignins), (2) polymeric thickening agents (e.g. starches or gums), (3) liquid mediums (e.g. edible oils), and (4) other additives (e.g. surfactants).

To prepare the compositions, dry ingredients (e.g. lignins, gums, starch, etc.) were measured and combined in a beaker. Said ingredients were slowly mixed with a spatula until a reasonably homogenous dry mixture was obtained. A required amount of a select liquid medium (e.g. canola oil, etc.) was measured using a graduated cylinder, then added to the beaker containing said dry mixture, and stirred slowly with a spatula until no dry powder or separated liquid medium was observed. The compositions were then considered ready for use.

### Exemplary Formulations

Hydrogel-forming compositions were prepared using sodium lignosulfonate, ammonium lignosulfonate, a kraft lignin (Amallin Lignin A and Amallin Lignin B), or a hydrolysis lignin as the at least one lignin, and corn starch, xanthan gum, guar gum or mixtures thereof as the at least one polymeric thickening agent. The exemplary hydrogel-forming compositions of the present application comprised from 3 to 10 wt % of the at least one lignin, up to 10 wt % corn starch and up to 25 wt % guar and/or xanthan gum. Exemplary compositions are described in greater detail in the Examples below.

### General Method for Producing Hydrogels

Hydrogels were prepared from liquid concentrates by mixing the liquid concentrate with fresh tap water in a beaker.

General Test Methods for Evaluating Liquid Concentrates and/or Hydrogels

### Viscosity Testing

The viscosities of the hydrogel-forming compositions and hydrogels formed from said compositions were determined using a Brookfield LVDVE viscometer with a CS-34 spindle. Each sample was added to a small sample adapter, and viscosity was tested at 6 RPM, 30 RPM and 60 RPM at room temperature. The hydrogels tested were formed by mixing 2 wt % of a hydrogel-forming composition with 98 wt % water.

### Settling/Stability Testing

Each hydrogel-forming composition is a suspension, from which solid ingredients could settle out slowly over time, resulting in a bi-phasic mixture with a liquid layer on top.

Settling tests were used to quantify separation and test the stability of said compositions. In each settling test, the tested hydrogel-forming composition (45 g) was added to a graduated cylinder, covered with parafilm and heated at 50° C. in an oil bath overnight. The sample was allowed to cool throughout the following day before the settling was determined. As settling occurred in the cylinder, volume of said liquid top layer could be continuously recorded until settlement was complete. Test results are shown as top layer volume in total volume of liquid concentrate. Test results are reported after 1 day and as a four day average.

### Burn Tests

Burn tests were conducted to determine the ability of hydrogels formed from specific hydrogel-forming compositions to resist a direct flame. For each burn test, a piece of cardboard was used in conjunction with a test hydrogel. The cardboard was coated with 10 g of hydrogel and allowed to stand vertical for 60 seconds to allow any hydrogel that would not adhere to the cardboard to drip off. The hydrogel-coated cardboard was then exposed to a flame from a propane torch held 6 inches from the cardboard. The recorded burn times are the length of time it took for the cardboard to char and/or catch on fire.

### Example 1: Lignin-Containing Composition and Hydrogel Viscosities

A series of representative hydrogel-forming compositions were prepared as described above. The viscosities of the compositions tested are shown in Table 1, with specific differences between the compositions noted. Each of the samples tested included the same liquid medium (canola oil), the same combination of gums (guar gum and xanthan gum), and the same property modifying additives, in the same amounts.

TABLE 1
Hydrogel-forming composition viscosities

| | | Viscosity | |
|---|---|---|---|
| Sample | Composition Differences | 30 RPM | 60 RPM |
| 20-70 | Lignin: 0% | 800 cPs | 694 cPs |
| | Starch: 13% (corn) | | |
| 073 | Lignin: 5% (ammonium | 732 cPs | 612 cPs |
| | lignosulfonate) | | |
| | Starch: 8% (corn) | | |
| 074 | Lignin: 5% (sodium | 860 cPs | 694 cPs |
| | lignosulfonate) | | |
| | Starch: 8% (corn) | | |

Hydrogels containing 2 wt % of the compositions described in Table 1 were prepared using water according to the method described above. The viscosities of the hydrogels tested are shown in Table 2.

TABLE 2
Hydrogel viscosities

| | Viscosity | |
|---|---|---|
| Sample | 30 RPM | 60 RPM |
| 20-70 | 1000 cPs | 650 cPs |
| 073 | 752 cPs | 436 cPs |
| 074 | 760 cPs | 464 cPs |

The data in Tables 1 and 2 demonstrate that similar hydrogel and hydrogel-forming composition viscosities may be obtained for compositions differing only by the replacement of a specific amount of starch with an equal amount of lignin.

### Example 2: Settling/Stability Testing

Settling/Stability tests were conducted for selected hydrogel-forming compositions according to the method described above. The results are shown in Table 3, with specific differences between the compositions noted. Each of the samples tested included the same combination of gums (guar gum and xanthan gum), and the same property modifying additives, in the same amounts. In samples 081 and 082, to account for the reduced quantity of the combination of lignin and starch present, the amount of liquid medium (canola oil) was increased by 8 wt % as compared to the amount used in samples 20-70, 011 and 012.

TABLE 3
Settling test results for lignin and non-lignin containing
hydrogel-forming compositions

| | | Percent | Percent |
|---|---|---|---|
| | | Settling | Settling |
| Sample | Composition Differences | (Day 1) | (4-Day Average) |
| 20-70 | Lignin: 0% | 2.3 | 4.6 |
| | Starch: 13 % (corn) | | |
| 081 | Lignin: 5% (Amallin Lignin A) | 2.3 | 7.8 |
| | Starch: 0% | | |
| 011 | Lignin: 3% (Amallin Lignin A) | 2.3 | 2.3 |
| | Starch: 10% (corn) | | |
| 082 | Lignin: 5% (Amallin Lignin B) | 2.2 | 3.6 |
| | Starch: 0% | | |
| 012 | Lignin: 3% Amallin Lignin B) | 2.2 | 2.2 |
| | Starch: 10% (corn) | | |

The data in Table 3 demonstrates that replacement of a specific amount starch with an equal amount of lignin leads to hydrogel-forming compositions with comparable, if not better, stability than compositions not containing lignin. The data further shows that complete removal of starch and inclusion of lignin, even in smaller quantities, may lead to less stable hydrogel-forming compositions.

### Example 3: Burn Tests

Burn tests were conducted for selected hydrogels according to the method described above. The results are shown in Table 4, with specific differences between the compositions noted. Each of the samples tested included the same liquid medium (canola oil), the same combination of gums (guar gum and xanthan gum), and the same property modifying additives, in the same amounts.

TABLE 4
Burn test results for lignin and non-lignin containing
hydrogel-forming compositions

| Sample | Composition Differences | Burn time (sec) |
|---|---|---|
| 121 | Lignin: 0% | 52.8 |
| | Starch: 13.1% (corn) | |
| 130 | Lignin: 5.0% (ammonium | 50.3 |
| | lignosulfonate) | |
| | Starch: 8.1% (corn) | |
| 129 | Lignin: 5.0% (sodium | 63.4 |
| | lignosulfonate) | |
| | Starch: 8.1% (corn) | |

The data in Table 4 demonstrate that replacement of a specific amount starch with an equal amount of lignin leads to hydrogel-forming compositions with comparable, if not better, burn times than compositions not containing lignin.

Cumulatively, the foregoing data shows that the tested hydrogel-forming compositions and hydrogels of the present invention are effective at forming water-enhancing, fire-suppressing and/or fire-retarding hydrogels.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference. Although the foregoing invention has been described in some detail by way of illustration and example for purposes of clarity of understanding, it is readily apparent to those of ordinary skill in the art in light of the teachings of this invention that certain changes and modifications may be made thereto without departing from the scope of the appended claims.

### Embodiments

Particular embodiments of the invention include, without limitation, the following:
1. A composition comprising:
   (a) at least one lignin; and
   (b) at least one polymeric thickening agent,
wherein mixture of said composition with water or an aqueous solution forms a fire suppressing and/or fire-retarding hydrogel.
2. The composition of paragraph 1 wherein the at least one lignin comprises a kraft lignin, a lignosulfonate, an organosolv lignin, a soda lignin, a hydrolysis lignin, a derivative thereof, or a mixture thereof.
3. The composition of paragraph 2, wherein the hydrolysis lignin is produced by a process comprising mechanically refining lignocellulosic biomass and enzymatic hydrolysis of the mechanically refined lignocellulosic biomass, wherein the process optionally further comprises functionalizing the hydrolyzed lignocellulosic biomass.
4. The composition of paragraph 3, wherein mechanically refining the lignocellulosic biomass comprises mechanical pulping (RMP), thermomechanical pulping (TMP), chemithermomechanical pulping (CTMP) or chemimechanical pulping (CMP), preferably TMP.
5. The composition of any one of paragraphs 1 to 4, wherein the at least one lignin interacts with the at least one polymeric thickening agent via one or more intermolecular forces.
6. The composition of paragraph 5, wherein the at least one lignin interacts with the at least one polymeric thickening agent via ionic interactions.
7. The composition of paragraph 5 or 6, wherein the at least one lignin interacts with the at least one polymeric thickening agent via hydrogen bonding.
8. The composition of any one of paragraphs 5 to 7, wherein the at least one lignin interacts with the at least one polymeric thickening agent via van der Waals forces.
9. The composition of any one of paragraphs 1 to 8, wherein the at least one lignin has an average particle size of no greater than 500 nm, no greater than 400 nm, no greater than 300 nm, no greater than 200 nm, no greater than 100 nm, no greater than 50 nm, no greater than 10 nm, or no greater than 5 nm.
10. The composition of any one of paragraphs 1 to 9, wherein the composition comprises about 10 to about 75 wt % of a combination of the at least one lignin and the at least one polymeric thickening agent, for example, about 10 to about 65 wt % of the combination, about 10 to about 55 wt % of the combination, about 10 to about 45 wt % of the combination, about 20 to about 45 wt % of the combination, about 20 to about 40 wt % of the combination, about 25 to about 40 wt % of the combination, or about 30 to about 40 wt % of the combination.
11. The composition of any one of paragraphs 1 to 10, wherein the at least one lignin:at least one polymeric thickening agent ratio, measured in terms of the wt % of each component comprised in the composition, is between about 1:1 and about 1:20, for example, between about 2:3 and about 1:15, or between about 1:2 and about 1:12.
12. The composition of any one of paragraphs 1 to 11, wherein the at least one polymeric thickening agent comprises at least one biopolymeric thickening agent, at least one non-biopolymeric thickening agent, or a mixture thereof.
13. The composition of paragraph 12, wherein the at least one polymeric thickening agent comprises at least one biopolymeric thickening agent.
14. The composition of paragraph 12 or 13, wherein the at least one polymeric thickening agent comprises at least one polysaccharide, at least one protein, or a mixture thereof.
15. The composition of paragraph 14, wherein the at least one polysaccharide comprises at least one starch, at least one polysaccharide gum, at least one cellulosic polymer, or a mixture thereof.
16. The composition of paragraph 15, wherein the at least one starch is corn starch, wheat starch, arrowroot, potato starch, tapioca, rice starch, or a mixture thereof.
17. The composition of paragraph 15 or 16, wherein the at least one polysaccharide gum is xanthan gum, guar gum, acacia gum, diutan gum, welan gum, gellan gum, or a mixture thereof.
18. The composition of any one of paragraphs 15 to 17, wherein the at least one cellulosic polymer is cellulose, carboxymethylcellulose, hydroxyethylcellulose, hydroxypropylcellulose, or a mixture thereof.
19. The composition of any one of paragraphs 12 to 18, wherein the at least one polymeric thickening agent comprises two or more polysaccharide gums.
20. The composition of any one of paragraphs 12 to 18, wherein the at least one polymeric thickening agent comprises at least one polysaccharide gum and at least one cellulosic polymer.
21. The composition of any one of paragraphs 12 to 18, wherein the at least one polymeric thickening agent comprises at least one starch and at least one polysaccharide gum.
22. The composition of any one of paragraphs 12 to 18, wherein the at least one polymeric thickening agent comprises at least one starch and two or more polysaccharide gums.
23. The composition of any one of paragraphs 12 to 18, wherein the at least one polymeric thickening agent comprises at least one starch, at least one polysaccharide gum and at least one cellulosic polymer.
24. The composition of any one of paragraphs 21 to 23, wherein the wt % of the at least one lignin comprised in the composition is equal to or less than the wt % of the at least one starch.
25. The composition of any one of paragraphs 12 to 24, wherein the at least one polymeric thickening agent comprises at least one non-biopolymeric thickening agent.
26. The compositions of paragraph 25, wherein the at least one non-biopolymeric thickening agent comprises a polymer comprising an acrylic acid, an acrylamide, a vinyl alcohol, a derivative thereof, or a mixture thereof.
27. The composition of paragraph 25, wherein the at least one non-biopolymeric thickening agent comprises a copolymer of acrylamide and an acrylic acid derivative.
28. The composition of paragraph 25, wherein the at least one non-biopolymeric thickening agent comprises a polymer of at least one of a salt of acrylate and acrylamide.
29. The composition of paragraph 25, wherein the at least one non-biopolymeric thickening agent comprises a terpolymer of an acrylate salt, acrylamide and a 2-acrylamido-2-methylpropanesulfonic acid (AMPS) salt.
30. The composition of paragraph 25, wherein the at least one non-biopolymeric thickening agent comprises an acrylic acid copolymer cross linked with a polyalkenyl polyether.
31. The composition of paragraph 25, wherein the at least one non-biopolymeric thickening agent comprises a cross-linked polyacrylic acid; a cross-linked, partially neutralized polyacrylic acid; a cross-linked, fully neutralized polyacrylic acid; or a mixture thereof.
32. The composition of paragraph 25, wherein the at least one non-biopolymeric thickening agent comprises a co-polymer of acrylamide and an acrylic acid derivative, maleic acid anhydride, itaconic acid, 2-hydroxy ethyl acrylate, polyethylene glycol dimethacrylate, allyl methacrylate, tetraethyleneglycol dimethacrylate, triethyleneglycol dimethacrylate, diethleneglycol dimethacrylate, glycerol dimethacrylate, hydroxypropyl methacrylate, 2-hydroxyethyl methacrylate, hydroxypropyl methacrylate, 2-hydroxyethyl methacrylate, 2-tert-butyl aminoethyl methacrylate, dimethylaminopropyl methacrylamide, 2-dimethylaminoethyl methacrylate, hydroxypropyl acrylate, trimethylolpropane trimethacrylate, a 2-acrylamido-2-methylpropanesulfonic acid (AMPS) derivative, or a mixture thereof.
33. The composition of any one of paragraphs 1 to 32, further comprising a fire retardant additive.
34. The composition of paragraph 33, wherein the fire retardant additive comprises alumina trihydrate, magnesium hydroxide, huntite, hydromagnesite, at least one ammonium polyphosphate, at least one ammonium phosphate, at least one ammonium sulfate, or a mixture thereof.
35. The composition of paragraph 33, wherein the fire retardant additive comprises at least one high molecule weight ammonium polyphosphate, at least one low molecular weight ammonium polyphosphate, at least one ammonium phosphate, at least one ammonium sulfate, or a mixture thereof.
36. The composition of paragraph 33, wherein the fire retardant additive comprises at least one ammonium polyphosphates having an average chain length of less than 20 phosphorus atoms.
37. The composition of any one of paragraphs 1 to 36, further comprising at least one liquid medium.
38. The composition of paragraph 37, wherein the at least one liquid medium comprises an edible oil.
39. The composition of paragraph 38, wherein the edible oil is a vegetable oil.
40. The composition of paragraph 39, wherein the vegetable oil is canola oil, castor oil, or a mixture thereof.
41. The composition of any one of paragraphs 1 to 40, further comprising at least one suspending agent.
42. The composition of paragraph 41, wherein the at least one suspending agent comprises at least one non-particulate suspending agent, at least one particulate suspending agent, or a mixture thereof.
43. The composition of paragraph 42, wherein the at least one non-particulate suspending agent comprises a lecithin, a lysolecithin, a polysorbate, a sodium caseinate, a monoglyceride, a fatty acid, a fatty alcohol, a glycolipid, a protein, or a mixture thereof.
44. The composition of paragraph 42 or 43, wherein the at least one particulate suspending agent comprises silica, glycogen particles, a clay, an organophilically modified clay, or a mixture thereof.
45. The composition of any one of paragraphs 1 to 44, wherein the composition has a viscosity of from about 400 to about 1400 cPs when measured using a Brookfield LVDVE viscometer with a CS-34 spindle at 30 RPM.
46. The composition of any one of paragraphs 1 to 45, wherein the composition has a viscosity of from about 350 to about 1100 cPs when measured using a Brookfield LVDVE viscometer with a CS-34 spindle at 60 RPM.
47. The composition of any one of paragraphs 1 to 46, wherein the one-day percent settling of the composition at 50° C. is equal to or less than about 10%, for example, equal to or less than about 8%, equal to or less than about 6%, equal to or less than about 4%, equal to or less than about 3%, equal to or less than about 2% or equal to or less than about 1%.
48. The composition of any one of paragraphs 1 to 47, wherein the four-day average percent settling of the composition at 50° C. is equal to or less than about 10%, for example, equal to or less than about 8%, equal to or less than about 6%, equal to or less than about 4%, equal to or less than about 3% or equal to or less than about 2%.
49. The composition of any one of paragraphs 1 to 48, wherein mixture of said composition with water or an aqueous solution forms a fire suppressing and fire-retarding hydrogel.
50. A hydrogel, comprising: 0.1-30 wt % of the composition of any one of paragraphs 1 to 49; and 70-99.9 wt % of water or an aqueous solution, wherein the hydrogel is a fire-suppressant and/or fire retardant, useful for one or more of fire-fighting, fire-suppression, and fire-prevention.
51. The hydrogel of paragraph 50, wherein the hydrogel exhibits non-Newtonian fluidic, pseudoplastic or thixotropic behaviour.
52. The hydrogel of paragraph 50 or 51, wherein the hydrogel's viscosity decreases under stress, and the hydrogel's viscosity increases after the stress ceases or has been removed.
53. The hydrogel of any one of paragraphs 50 to 52, wherein the hydrogel has a viscosity of from about 400 to about 1250 cPs when measured using a Brookfield LVDVE viscometer with a CS-34 spindle at 30 RPM.
54. The hydrogel of any one of paragraphs 50 to 53, wherein the hydrogel has a viscosity of from about 230 to about 800 cPs when measured using a Brookfield LVDVE viscometer with a CS-34 spindle at 60 RPM.
55. A method of fighting a fire, comprising applying the hydrogel of any one of paragraphs 50 to 54 to active fire and/or areas surrounding the active fire.
56. The method of paragraph 55, wherein the hydrogel is applied using a single deployment means.

1. A composition comprising:
(a) at least one lignin; and
(b) at least one polymeric thickening agent,
wherein mixture of said composition with water or an aqueous solution forms a fire suppressing and/or fire-retarding hydrogel.

2. The composition of claim 1 wherein the at least one lignin comprises a kraft lignin, a lignosulfonate, an organosolv lignin, a soda lignin, a hydrolysis lignin, a derivative thereof, or a mixture thereof.

3. The composition of claim 1, wherein the at least one lignin has an average particle size of no greater than 500 nm, no greater than 400 nm, no greater than 300 nm, no greater than 200 nm, no greater than 100 nm, no greater than 50 nm, no greater than 10 nm, or no greater than 5 nm.

4. The composition of claim 1, wherein the composition comprises about 10 to about 75 wt % of a combination of the at least one lignin and the at least one polymeric thickening agent, for example, about 10 to about 65 wt % of the combination, about 10 to about 55 wt % of the combination, about 10 to about 45 wt % of the combination, about 20 to about 45 wt % of the combination, about 20 to about 40 wt % of the combination, about 25 to about 40 wt % of the combination, or about 30 to about 40 wt % of the combination.

5. The composition of claim 1, wherein the at least one lignin:at least one polymeric thickening agent ratio, measured in terms of the wt % of each component comprised in the composition, is between about 1:1 and about 1:20, for example, between about 2:3 and about 1:15, or between about 1:2 and about 1:12.

6. The composition of claim 1, wherein the at least one polymeric thickening agent comprises at least one polysaccharide, which comprises at least one starch, at least one polysaccharide gum, at least one cellulosic polymer, or a mixture thereof.

7. The composition of claim 1, wherein the at least one polymeric thickening agent comprises two or more polysaccharide gums.

8. The composition of claim 6, wherein the at least one polymeric thickening agent comprises at least one starch and at least one polysaccharide gum, and wherein the wt % of the at least one lignin comprised in the composition is equal to or less than the wt % of the at least one starch.

9. The composition of claim 8, wherein the at least one starch is corn starch.

10. The composition of claim 8, wherein the at least one polysaccharide gum is xanthan gum, guar gum, or a mixture thereof.

11. The composition of claim 1, further comprising a fire retardant additive.

12. The composition of claim 1, further comprising at least one liquid medium.

13. The composition of claim 1, further comprising at least one suspending agent.

14. The composition of claim 1, wherein the composition has a viscosity of from about 400 to about 1400 cPs when measured using a Brookfield LVDVE viscometer with a CS-34 spindle at 30 RPM, and/or a viscosity of from about 350 to about 1100 cPs when measured using a Brookfield LVDVE viscometer with a CS-34 spindle at 60 RPM.

15. The composition of claim 1, wherein the one-day percent settling of the composition at 50° C. is equal to or less than about 10%, for example, equal to or less than about 8%, equal to or less than about 6%, equal to or less than about 4%, equal to or less than about 3%, equal to or less than about 2% or equal to or less than about 1%.

16. The composition of claim 1, wherein the four-day average percent settling of the composition at 50° C. is equal to or less than about 10%, for example, equal to or less than about 8%, equal to or less than about 6%, equal to or less than about 4%, equal to or less than about 3% or equal to or less than about 2%.

17. The composition of claim 1, wherein mixture of said composition with water or an aqueous solution forms a fire suppressing and fire-retarding hydrogel.

18. A hydrogel, comprising: 0.1-30 wt % of the composition of claim 1; and 70-99.9 wt % of water or an aqueous solution, wherein the hydrogel is a fire-suppressant and/or fire retardant, useful for one or more of fire-fighting, fire-suppression, and fire-prevention.

19. The hydrogel of claim 18, wherein the hydrogel has a viscosity of from about 400 to about 1250 cPs when measured using a Brookfield LVDVE viscometer with a CS-34 spindle at 30 RPM, and/or a viscosity of from about 230 to about 800 cPs when measured using a Brookfield LVDVE viscometer with a CS-34 spindle at 60 RPM.

20. A method of fighting a fire, comprising applying the hydrogel of claim 18 to active fire and/or areas surrounding the active fire.
